(19) United States
(12) Patent Application Publication
(10) Pub. No.: US 2020/0072173 A1
(43) Pub. Date: Mar. 5, 2020

(54) INJECTOR

(71) Applicant: NIKKI CO. LTD, Kanagawa -ken (JP)

(72) Inventors: Takayuki Endo, Kanagawa-ken (JP); Tsutomu Murakami, Kanagawa-ken (JP)

(21) Appl. No.: 16/558,029

(22) Filed: Aug. 30, 2019

(30) Foreign Application Priority Data
Sep. 5, 2018 (JP) 2018-166295

(51) Int. Cl. F02M 51/06; F02M 61/18; F02M 61/20; F02M 61/04; B05B 1/30

(52) U.S. Cl. CPC F02M 51/061; F02M 61/18; F02M 2200/50; F02M 61/04; B05B 1/3013; F02M 61/20

(57) ABSTRACT

An electromagnetically driven injector may include an electromagnetic coil, a movable core, a doughnut-shaped fixed core, a valve, a coil spring, and at least one plate spring. When the electromagnetic coil is not energized, a valve closed state may be maintained by a valve element of the valve normally biased in a valve closed direction by cooperation of the coil spring and the at least one plate spring. When the electromagnetic coil is energized, the valve may be opened by the movable core being attracted to the doughnut-shaped fixed core, the valve element attached to the movable core disposed so as to be attracted to the fixed core disposed on a center of the electromagnetic coil being disposed along a stroke direction in the coil spring, the at least one plate spring being provided at a right angle to the stroke direction of the valve element, a central portion of the at least one plate spring being fixed at a fixation position while sandwiched between the valve element and the movable core, both of the valve element and the movable core being in contact with the fixation position, a peripheral edge portion of the at least one plate spring being fixed while sandwiched on a nozzle side. The fixation position of the movable core and the valve element that sandwich the central portion of the at least one plate spring may be assembled by laser welding.

### CROSS-REFERENCE TO RELATED APPLICATIONS

This application claims priority to Japanese Patent Application No. 2018-166295, filed on Sep. 5, 2018, the contents of which are hereby incorporated by reference in its entirety.

### TECHNICAL FIELD

The present invention relates to an electromagnetically driven injector that injects fuel at a flow rate required by an engine, in particular, to a normally closed injector that secures sealability for the time when a valve is closed by a valve element of an on-off valve (fuel amount adjusting valve) pushed against a valve seat by the spring load of a coil spring.

### BACKGROUND

Electromagnetically driven injectors, in which an on-off valve is opened by a movable core suctioned by energizing and exciting an electromagnetic coil, have been traditionally used. An electric signal for actuating the on-off valve is set to be an actuating signal of approximately 0.001 to 0.02 seconds. In order to accomplish an object of accurately controlling fuel by repetition of such a remarkably short actuation time, a fuel injecting valve is required to have high responsiveness. In recent years, extremely high durability has also been required owing to the needs of users for high quality.

Examples of a valve spring for closing a valve element of an injector include a valve spring having a coil spring mounted into the space between a fixed core and a movable core and that having a thin plate spring through which fuel can pass. In the latter one, an outer peripheral edge portion is fixed, and the movable core and the valve element are attached to the displaceable center. An injector that injects gas fuel such as compressed natural gas (CNG) has no lubricant differently from an injector that injects liquid fuel. A structure having a plate spring that can be supported in a floating manner without a sliding part and can be linearly moved is regarded to have advantage in the durability and responsiveness.

Although the sealability for the time when a valve is closed is secured by the spring load caused by elastic repulsive force of the plate spring in the injector in which a valve element is biased by the plate spring, however, the reduction of the spring load accompanying the decrease of the elastic repulsive force of the plate spring due to, for example, deterioration over time of a material of the plate spring causes insufficient sealability of the on-off valve, which tends to cause a problem of fuel leakage for the time when the valve is closed.

JP 2009-91998 A discloses an injector in which a valve element can be kept closed for a long time by the spring load of a valve spring. A coil spring is provided along the stroke direction of the valve, and cooperation of two springs, a plate spring and a coil spring, for the time when the valve is closed keeps the valve closed.

In order to obtain the same engine output as an injector that injects liquid fuel, an injector that injects gas fuel generally needs a fuel passage cross-sectional area larger than the injector that injects liquid fuel, leading to a larger displacement amount of the valve element. A plate-spring structure inevitably increases an injector main body in size owing to stress applied to the plate spring. It is known that the increase in size can be prevented without losing the advantage of the plate-spring structure by supporting the valve element in the middle of a floating on-off valve as disclosed in JP 2008-144693 A and using the coil spring as a return spring.

The injector as disclosed in JP 2008-144693 A is as illustrated in FIG. 2. An injector 1a includes an electromagnetic coil 3a, a fixed core 11a, and a movable core 5a. A valve element 21a is provided below (on the downstream side of) the movable core 5a. One disc-shaped plate spring 6a provided at a right angle to the valve stroke direction supports these components. A coil spring 7a is provided above the valve element 21a along the valve stroke direction. The coil spring 7a is vertically disposed in compression so as to bias the valve element 21a of an on-off valve 2a in the valve closed direction.

Furthermore, the plate spring 6a is supported at a right angle to a stroke of the valve element 21a by the peripheral edge portion of the plate spring 6a is sandwiched and fixed between a nozzle 9a and a yoke 4a and the central portion of the plate spring 6a is sandwiched and fixed between the valve element 21a and a movable core 5a.

Unfortunately, the traditional injector has difficulty in mass production. The traditional injector has a structure in which the plate spring 6a is sandwiched and supported by performing screwing with an assembling screw part at both the fixation positions 12a, which correspond to an inner peripheral surface of the movable core 5a and an outer peripheral surface of the valve element 21a. In order to perform accurate opening and closing with high responsiveness and durability as an injector having a valve element supported to a plunger, individual components are required to have high precision, and precision is required also for assembling operation. Threading processing is needed to form the assembling screw part. The processing takes time and effort, and chips are generated.

### SUMMARY

The present invention is intended to solve the above-described problems. An object of the present invention is to make a normally closed injector that can be easily assembled, can be manufactured in mass production, is inexpensive, and can exhibit accurate opening and closing operation. In the injector, a plate spring disposed in a direction at a right angle to a stroke direction supports a valve element, and a valve is kept closed by the spring load of a coil spring along a stroke direction of the valve element.

In an electromagnetically driven injector of the present invention, in which, when an electromagnetic coil is not energized, a valve closed state is maintained by a valve element normally biased in a valve closed direction by cooperation of a coil spring and a plate spring, and when an electromagnetic coil is energized, a valve is opened by a movable core attracted to a doughnut-shaped fixed core, the valve element attached to the movable core disposed so as to be attracted to the fixed core disposed on a center of the electromagnetic coil being disposed along a stroke direction in the coil spring, the plate spring being provided at a right angle to the stroke direction of the valve element, a central portion of the plate spring being fixed at a fixation position while sandwiched between the valve element and the movable core, both of the valve element and the movable core being in contact with the fixation position, a peripheral edge portion of the plate spring being fixed while sandwiched on a nozzle side, the fixation position of the movable core and the valve element that sandwich the central portion of the plate spring is assembled by laser welding.

In addition, in the present invention, the coil spring is laid between the fixed core and the valve element, and a seat surface of the valve element for the coil spring is formed at a position where the welded position is not put. There is no need to worry about deformation of the seat surface for the coil spring caused by the laser welding.

According to the present invention, a normally closed injector that can be easily assembled, can be manufactured in mass production, is inexpensive, and can exhibit accurate opening and closing operation can be provided.

### BRIEF DESCRIPTION OF DRAWINGS

FIG. 1 is a view of a vertical cross-sectional portion illustrating an injector, with a valve closed, according to an embodiment of the present invention; and

FIG. 2 is a view of a vertical cross-sectional portion illustrating an injector, with a valve closed, according to an embodiment of a traditional example.

### DETAILED DESCRIPTION

A preferred embodiment of the present invention will be described in detail below with reference to the drawings.

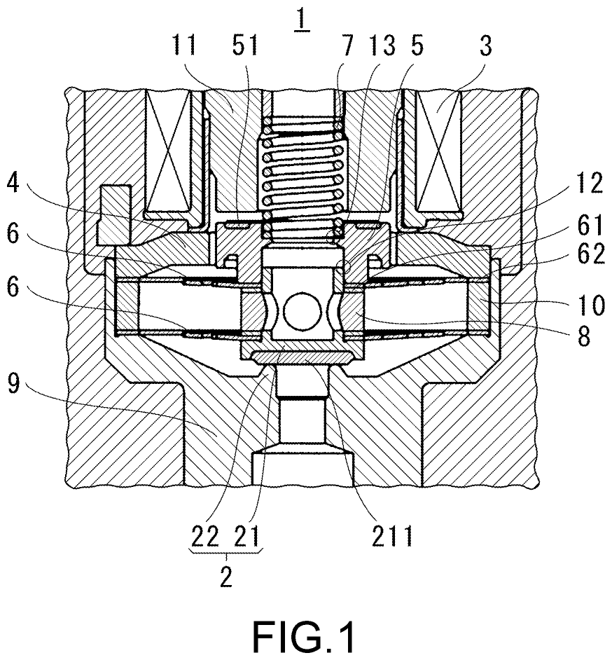

FIG. 1 schematically illustrates a vertical cross-sectional portion centering on an on-off valve 2 of an electromagnetically driven injector 1. The on-off valve 2 includes a valve element 21 and a valve seat 22. The injector 1 supplies fuel to a gas engine for carrying out a preferred embodiment of the present invention. The injector 1 includes an electromagnetic coil 3, a lower plate 4, and a movable core 5. The valve element 21 is provided below (on the downstream side of) the movable core 5. A pair of disc-shaped plate springs 6, 6 provided at a right angle to the valve stroke direction support these components.

In addition, central portions 61 of the plate springs 6, 6 in the present embodiment are fixed, via a columnar inner collar 8 disposed on the outer periphery of the valve element 21, by being sandwiched between the valve element 21 and the movable core 5 attached to the valve element 21. A nozzle 9 and a hollow circular-plate-shaped outer collar 10 disposed along the inner periphery of the nozzle 9 support an outer peripheral edge 62 in a direction at a right angle to a stroke of the valve element 21. In particular, the inner collar 8 and the outer collar 10 are juxtaposed at the same height and at a predetermined distance to each other.

In particular, in the present embodiment, in order to support the central portions 61, 61 of the plate springs 6, 6 to the valve element 21, the movable core 5 is attached and assembled to the valve element 21 by laser welding at a fixation position 12 with which both of the central portions 61, 61 and the valve element 21 are in contact.

In addition, a coil spring 7 is provided above the valve element 21 along the valve stroke direction. The coil spring 7 is vertically disposed in compression so as to bias the valve element 21 of the on-off valve 2 in the valve closed direction. In particular, in the present embodiment, a seat surface 13 of the valve element 21 for the coil spring 7 is formed at a position where the welded fixation position 12 is not put. There is no need to worry about deformation of the seat surface 13 for the coil spring 7 caused by the laser welding.

The injector with the above-described configuration of the present embodiment opens the on-off valve 2 against biasing force of the coil spring 7 and the plate springs 6, 6 by generating magnetic force on a fixed core 11 by energizing and exciting the electromagnetic coil 3 to suction the movable core 5, which is a magnetic substance. The injector of the embodiment can perform accurate opening and closing with high responsiveness and durability required for injectors.

In particular, in the present embodiment, in order to support the central portions 61, 61 of the plate springs 6, 6 to the valve element 21, the movable core 5 is attached and assembled to the valve element 21 by laser welding at a fixation position 12 with which both of the central portions 61, 61 and the valve element 21 are in contact. Threading processing is thus unnecessary in contrast to attachment with a traditional assembling screw part. The unnecessity promotes labor-saving in a manufacturing process, and makes chip disposal unnecessary, leading to easy mass production. In addition, a remarkably-high-precision part is not necessary. The injector of the present embodiment can be inexpensively provided, and has economical advantage.

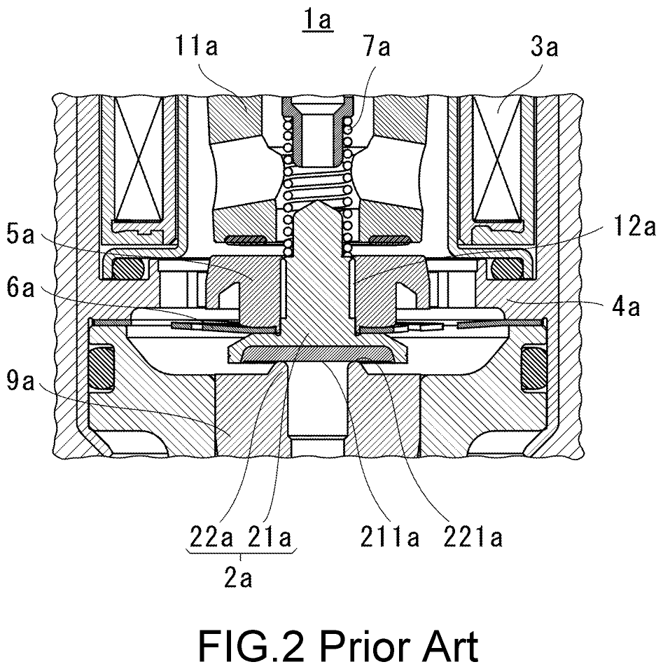

In the present embodiment, the structure, in which the two plate springs 6, 6 disposed at a predetermined distance support a valve element, is adopted. The structure is different from a plate-spring structure in which one plate spring supports the traditional valve element only at one point on a central portion. Also, in the traditional example in FIG. 2, similar action/effect can be exhibited by attaching and assembling the movable core 5 to the valve element 21 by using a laser welding unit instead of the assembling screw part at a portion of a fixation position 12a. When a plurality of plate springs 6 is used, operation is not destabilized by various disturbances, a valve rubber 211 and a stop rubber 51 are not worn unevenly at the time when the valve is opened or closed, a displacement amount of the valve element 21 and stress applied to the plate springs 6, 6 are not increased, the plate springs 6, 6 are not broken, and the function of the injector 1 is not damaged.

1. An electromagnetically driven injector comprising:
an electromagnetic coil;
a movable core;
a doughnut-shaped fixed core;
a valve having a valve element
a coil spring; and
at least one plate spring;
wherein, when the electromagnetic coil is not energized, a valve closed state is maintained by the valve element normally biased in a valve closed direction by cooperation of the coil spring and the at least one plate spring, and when the electromagnetic coil is energized, the valve is opened by the movable core attracted to the doughnut-shaped fixed core, the valve element attached to the movable core disposed so as to be attracted to the fixed core disposed on a center of the electromagnetic coil being disposed along a stroke direction in the coil spring, the at least one plate spring being provided at a right angle to the stroke direction of the valve element, a central portion of the at least one plate spring being fixed at a fixation position while sandwiched between the valve element and the movable core, both of the valve element and the movable core being in contact with the fixation position, a peripheral edge portion of the at least one plate spring being fixed while sandwiched on a nozzle side; and
wherein the fixation position of the movable core and the valve element that sandwich the central portion of the at least one plate spring is assembled by laser welding.

2. The injector according to claim 1, wherein the coil spring is laid between the fixed core and the valve element, and a seat surface of the valve element for the coil spring is formed at a position where the fixation position is not put.

3. The injector according to claim 1, further comprising a columnar inner collar disposed on an outer periphery of the valve element and by which the central portion of the plate spring is fixed at the fixation position.

4. The injector according to claim 3, further comprising a nozzle and a hollow circular-plate-shaped outer collar disposed along an inner periphery of the nozzle, the nozzle and outer collar supporting an outer peripheral edge of the plate spring such that the plate spring is at the right angle to the stroke direction of the valve element.

5. The injector according to claim 4, wherein the inner collar and the outer collar are juxtaposed at a same height and at a predetermined distance to each other.

6. The injector according to claim 1, wherein the at least one plate spring includes a pair of plate springs disposed at a predetermined distance from each other.
